(19) United States
(12) Patent Application Publication
(10) Pub. No.: US 2008/0069091 A1
(43) Pub. Date: Mar. 20, 2008

(54) Data Transfer Method, Apparatus and Computer Program Product

(76) Inventors: Tomer Cohen, Haifa (IL); Amiram Hayardeny, Beijing (CN); Aviad Zlotnick, D.N.G.T. (IL)

Correspondence Address: Stephen C. Kaufman;IBM CORPORATION, Intellectual Property Law Dept., P.O. Box 218, Yorktown Heights, NY, 10598, US

(21) Appl. No.: 11/533,478

(22) Filed: Sep. 20, 2006

(51) Int. Cl. H04L 12/56; H04J 3/24

(52) U.S. Cl. 370/389; 370/474

(57) ABSTRACT

The present invention provides a method, an apparatus and a computer program product for transferring a digital object from a source to a destination. The method includes splitting the digital object into a plurality of parts forming a first set of parts and a set of remaining parts. The method creates a credential record defining a relationship between the plurality of parts. The credential record includes retrieval information for the set of remaining parts. The method further includes transferring a first set of the parts along with the credential record to the destination using at least one push path. The method further includes fetching the set of remaining parts at the destination using the credential record to connect the destination to the source via at least one pull path. Further, the method includes recreating the digital object at the destination using the first set of parts, the credential record and a set of remaining parts.

### FIELD OF THE INVENTION

The present invention relates to the field of data transfer, and more specifically to a method and a computer program product for transferring large data objects from one location to another location.

### BACKGROUND

With the widespread use of computers, information exchange has increasingly become vital to everyday living. Remotely located users in different communication networks, who are spread over various geographic locations, need to share information. Typically, users store information as digital objects such as, but not limited to, digital files. Many users of multimedia applications wish to exchange multimedia files, which can be quite large, for example a file size exceeding one gigabyte in storage space. Distributing or sharing such large amounts of information between various users over a communication network such as the Internet can get problematic for majority of the users.

In a typical scenario, two users in different networks would ideally like to transfer some data between a source and a destination. In this case, a first user is at the source and a second user is the destination. Various techniques have been devised to enable such transfer of information, in the form of large digital objects. In one such approach, large files can be transferred over a communication network by uploading them on a central computer from the source, and thereafter downloading them from the destination. However, solutions like these are usually cumbersome for users having only basic knowledge of computing, because this requires more than basic knowledge of the computing environment.

For example, while copying files over a communication network, the user is required to have adequate knowledge of functioning of computer networks. For example, if FTP is used to transfer the digital object, then the user must possess the adequate skill set to operate an FTP client-server architecture. Similarly, in case of sharing the information over the Internet, the user must possess knowledge of the process of uploading the digital object on a hosting site at the source and thereafter retrieving it from the hosting site at the destination. Furthermore, in this case, there may even be a restriction on the maximum size of the digital object that can be uploaded on the hosting site.

Another widely used technique to transfer the digital object from the source to the destination involves copying the digital object at the source onto a digital portable media. Thereafter, the digital object is copied from the digital media onto the destination. However, the bottleneck, in this case, is the size of the digital media. The user must have the digital media of at least the size of the digital object, otherwise the digital object needs to be split between one or more digital media at the source, and combined at the destination to form the original digital object. Furthermore, the user must possess knowledge about file splitting and merging.

In yet another technique, a data meta-manager is provided between the source and the destination. The data meta-manager divides a large file into multiple files which are stored in different storage subsystems. Thereafter, these multiple files may be read from the different storage subsystems simultaneously and multiplexed at the destination. However, there is a dedicated need of one or more storage subsystems until the transfer of the digital object is complete at the destination. This leads to an unnecessary usage of storage resources for the large file transfer.

In yet another technique, the digital object is transferred over parallel connections. In this method, a number of connections are established between the source and the destination. Further, a send buffer is created to store several segments of the digital object at the source. Thereafter, the segments are read into the send buffer. Each segment in the send buffer is sent on one of the connections for delivery to the destination. In this approach, there may be a mismatch in the read cycle of the send buffer and speed of data transfer in the connection.

The aforementioned techniques suffer from some inherent problems. Primarily, the transfer of data is not transparent to the user, making significant user intervention and an advanced user skill set necessary. It is desirable that the data transfer should be performed using minimum storage resources and bandwidth. Also the data transfer should be independent of the number of storage resources available at the destination.

### SUMMARY

The invention is a method for transferring a digital object from a source to a destination. The method involves splitting the digital object into a plurality of parts including a first set of parts and a set of remaining parts. Further, a credential record is created which defines the relationship between the plurality of parts. The credential record comprises retrieval information for the set of remaining parts. Thereafter, according to the method, the first of parts along with the credential record are transferred to the destination using at least one push path. The set of remaining parts present at the destination are fetched using the credential record. The credential record thereby assists in connecting the destination to the source via at least one pull path. Thereafter, the digital object is recreated at the destination using the first set of parts, the credential record and the set of remaining parts.

Another embodiment of the present invention is a computer program product for transferring a digital object from a source to a destination. The computer program product comprises a computer usable program code for splitting the digital object into a plurality of parts, including a first set of parts and a set of remaining parts. A computer usable program code for creating a credential record defining a relationship between the plurality of parts is also provided. The credential record includes retrieval information of the set of remaining parts. The computer program product further comprises a computer usable program code for transferring the first set of parts along with the credential record to the destination using at least one push path. The computer program product further comprises a computer usable program code for fetching the set of remaining parts at the destination using the credential record to connect the destination to the source via at least one pull path. Further, the computer program product comprises a computer usable program code for recreating the digital object at the destination using the first set of parts, the credential record, and the set of remaining parts.

Another embodiment of the present invention provides an apparatus for transferring a digital object from a source to a destination. The apparatus includes a splitting module for splitting the digital object into a plurality of parts including a first set of parts and a set of remaining parts. The apparatus further includes a credential record creator to create a credential record defining a relationship between the plurality of parts. The credential record includes retrieval information for the set of remaining parts. Further, the apparatus includes a transferring module to transfer the first set of parts with the credential record to the destination, using at least one push path. The apparatus also includes a fetching module to fetch the set of remaining parts at the destination using the credential record to connect the destination to the source via at least one pull path. Further, the apparatus includes a recreating module to recreate the digital object at the destination using the first set of parts, the credential record, and the set of remaining parts.

### BRIEF DESCRIPTION OF DRAWINGS

The above and other items, features and advantages of the invention will be better understood by reading the following description of the invention in conjunction with the accompanying drawings wherein:

FIG. 1 shows a system environment for transferring a digital object from a source to a destination, in accordance with an embodiment of the present invention.

FIG. 2 illustrates a computer system used as a data transferring system in accordance with an embodiment of the present invention.

FIG. 3 is a flowchart depicting a method for transferring a digital object from a source to a destination, in accordance with one embodiment of the present invention.

FIG. 4 is a block diagram depicting a credential record, in accordance with an embodiment of the present invention.

FIG. 5 is a sample user interface suitable for use in conjunction with various embodiments of the invention.

### DETAILED DESCRIPTION

The present invention will now be explained with reference to the accompanying figures. Unless the context clearly requires otherwise, throughout the description and the claims, the words “comprise”, “comprising”, and the like are to be construed in an inclusive sense as opposed to an exclusive or exhaustive sense; that is to say, in a sense of “including, but not limited to”. Words using the singular or plural number also include the plural or singular number respectively. Additionally, the words “herein”, “hereunder”, “above”, “below”, and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The present invention provides a method for transferring a digital object from a source to a destination. The method is particularly useful to transfer a digital object of large size from the source to the destination. In the context of the foregoing description a digital object may be considered to be of large size if it cannot be transferred using basic transfer techniques. Basic transfer techniques are conventional transfer techniques known to a user with only “basic knowledge” of computing. For example, most users with “basic knowledge” of computing may be adept at using techniques such as, but not limited to, transferring digital objects using portable media, and sending digital objects as email attachments. Examples of portable media, include, but are not limited to, USB storage devices, compact discs (CD), and digital versatile discs (DVD). However, most basic transfer techniques have a maximum limit on the size of the digital object that they may transfer. For example, most email service providers impose a restriction on the maximum size of attached digital objects that they deliver. Further, the storage capacity of portable media is often not enough to store large files. Various embodiments of the present invention allow users to transfer large digital objects using basic transfer techniques. The digital object may be, but is not limited to, a digital file. The transfer of the digital object is performed with minimum user intervention and skill set requirement. Also, the transfer is performed irrespective of the maximum limit on the size of the digital object imposed by the basic transfer technique.

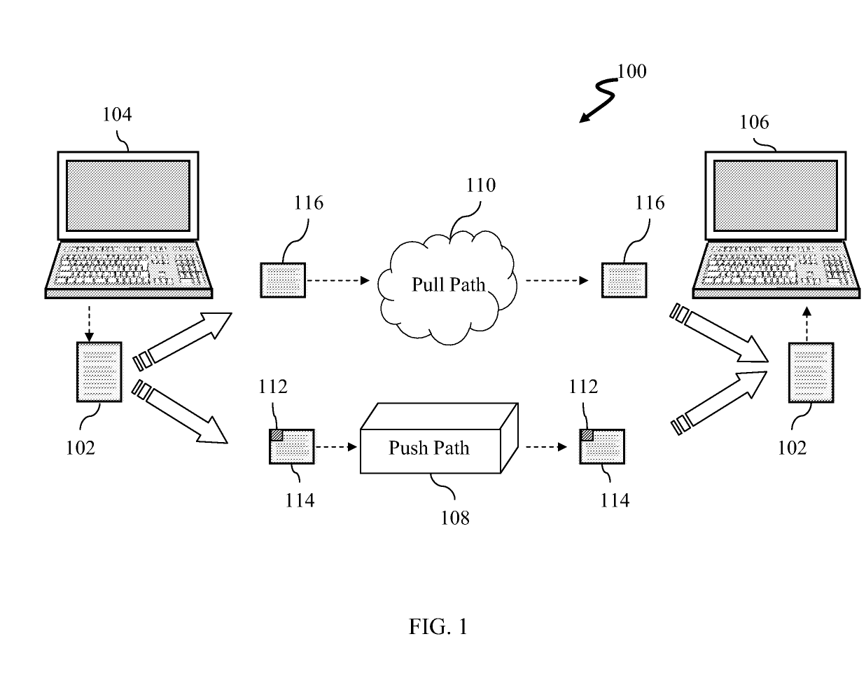

FIG. 1 shows an environment 100 for transferring a digital object 102 from a source 104 to a destination 106 in accordance with the present invention. In one embodiment of the present invention, the digital object 102 has a large size. In other words, storage space requirement for the digital object 102 is significantly large such that it cannot be transferred using a basic transfer technique. An exemplary value of digital object 102 may range from 700 MB to 10 GB. Transfer of such a large digital object poses a problem for a user wishing to transfer the file from source 104 to destination 106. In one embodiment of the present invention, the user transfers digital object 102 using a push path 108 and a pull path 1 10. The push path 108 may be, but is not limited to, a portable media and an email attachment. Examples of the portable media include, but are not limited to, a compact disc (CD), a digital versatile disc (DVD), a digital audio player such as an MP3/MP4 player, a holographic storage, a USB storage media, a Blu-ray disk, a magnetic storage media and the like. Further, the pull path 110 may be a communication network which includes, but is not limited to, an Internet file transfer, an email attachment, a Bluetooth connection, a file transfer protocol (FTP) connection, a peer-to-peer (P2P) connection, a radio frequency (RF) connection, a Wi-Fi connection, a code division multiple access (CDMA) connection, a Global System for Mobile Communications (GSM) connection, an Evolution-Data Optimized (EVDO) connection, a Universal Mobile Telecommunications System (UMTS) connection, a Wideband CDMA (WCDMA) connection and the like.

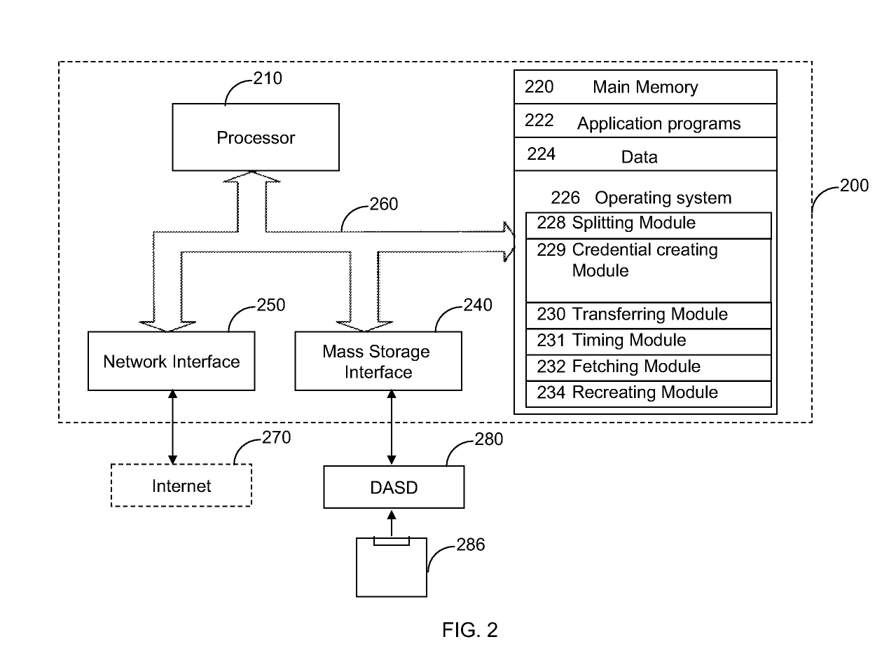

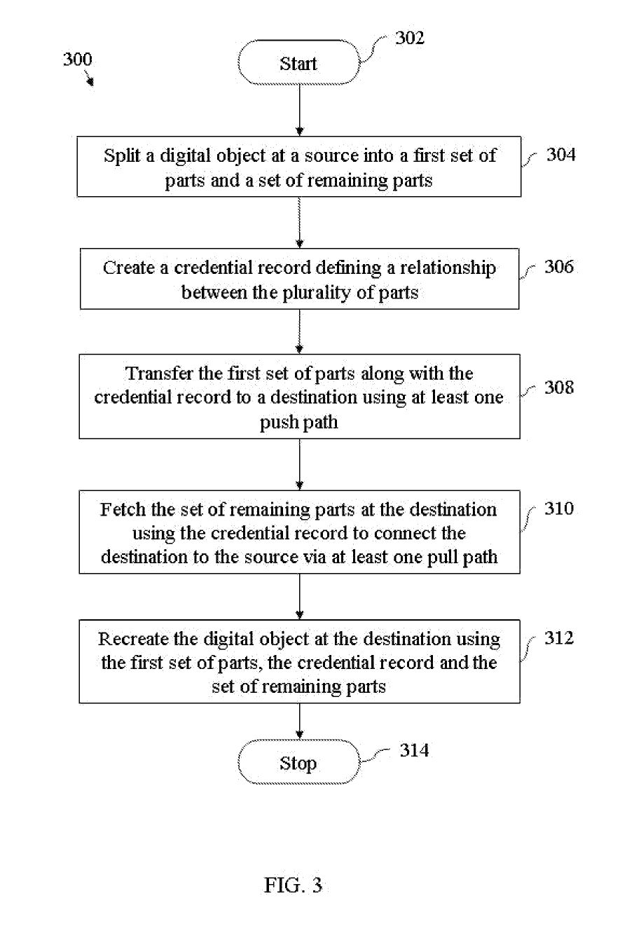

In one embodiment of the present invention, a user of source 104 transfers digital object 102 to destination 106. Source 104 splits digital object 102 into a plurality of parts. Source 104 further creates a credential record 112 that defines a relationship between the plurality of parts. The user then pushes a first set of parts 114 from the plurality of parts along with credential record 112 from source 104 to destination 106 via at least one push path 108. The size of parts split and copied to push path 108 must be less than or equal to the maximum size limit of push path 108. The part(s) that are not transferred via push path 108 are hereinafter referred to as a set of remaining parts 116. Destination 106 pulls the set of remaining parts 116 of the digital object 102 through the pull path 110. Thereafter, at destination 106, the plurality of parts of digital object 102 are merged back to recreate digital object 102. The method and computer program code used for transferring digital object 102, according to various embodiments of the present invention, are described in conjunction with FIGS. 2 and 3.

The present invention may take the form of an entirely hardware embodiment, an entirely software embodiment or an embodiment containing both hardware and software elements. In accordance with an embodiment of the present invention, the invention is implemented in software, which includes, but is not limited to firmware, resident software, microcode, etc.

Furthermore, the invention may take the form of a computer program product accessible from a computer-usable or computer-readable medium providing program code for use by, or in connection with, a computer or any instruction execution system. For the purposes of this description, a computer-usable or computer-readable medium may be any apparatus that may contain, store, communicate, propagate, or transport the program for use by, or in connection with, the instruction execution system, apparatus or device.

The medium may be electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CDROM), compact disk—read/write (CD-R/W) and DVD.

FIG. 2 depicts a block diagram of a computer system 200 in accordance with an embodiment of the present invention, which includes a processor 210, a main memory 220, a mass storage interface 240, and a network interface 250, all connected by a system bus 260. Those skilled in the art will appreciate that this system encompasses all types of computer systems: personal computers, midrange computers, mainframes, etc. Note that many additions, modifications, and deletions may be made to this computer system 200 within the scope of the invention. Examples of possible additions include a display, a keyboard, a cache memory, and peripheral devices such as printers.

Processor 210 may be constructed from one or more microprocessors and/or integrated circuits. Processor 210 executes program instructions stored in main memory 220. Main memory 220 stores programs and data that computer system 200 may access. Main memory 220 includes one or more application programs 222, data 224, an operating system 226. In accordance with one embodiment of the present invention, a software program for large file transfer also resides in the operating system 226. The software program includes several modules to be used for transferring the digital object 102 from source 104 to destination 106. In an embodiment, the software program includes a splitting module 228, a credential creating module 229, a transferring module 230, a timing module 231, a fetching module 232 and a recreating module 234. When computer system 200 starts, processor 210 initially executes some program instructions that invoke the operating system 226. Operating system 226 is a sophisticated program that manages the resources of computer system 200. For example, processor 210, main memory 220, mass storage interface 240, network interface 250 and system bus 260.

Application programs 222 are executed by processor 210 under the control of operating system 226. Application programs 222 may be run with program data 224 as input. Application programs 222 may also output their results as program data 224 in the main memory. Mass storage interface 240 allows computer system 200 to retrieve and store data from auxiliary storage devices such as magnetic disks (hard disks, diskettes) and optical disks (CD-ROM). These mass storage devices 280 are commonly known as Direct Access Storage Devices (DASD), and act as a permanent store of information. One suitable type of DASD 280 is a floppy disk drive 280 that reads data from and writes data to a removable media 286. The information from the DASD may be in many forms. Common forms are application programs and program data. Data retrieved through mass storage interface 240 is usually placed in main memory 220 where processor 210 may process it.

While main memory 220 and Direct Access Storage Device (DASD) 280 are typically separate storage devices, computer system 200 may use well known virtual addressing mechanisms that allow the programs of computer system 200 to run smoothly as if having access to a large, single storage entity, instead of access to multiple, smaller storage entities (e.g., main memory 220 and DASD device 280). Therefore, while certain elements are shown to reside in main memory 220, those skilled in the art will recognize that these are not necessarily all completely contained in main memory 220 at the same time. It should be noted that the term “memory” is used herein to generically refer to the entire virtual memory of computer system 200. In addition, an apparatus in accordance with the present invention may include any possible configuration of hardware and software that contains the elements of the invention, whether the apparatus is a single computer system or is comprised of multiple computer systems operating in sync with each other.

Network interface 250 allows computer system 200 to send and receive data to and from any network connected to computer system 200. This network may be a local area network (LAN), a wide area network (WAN), or more specifically, the Internet 270. Suitable methods of connecting to a network include known analog and/or digital techniques as well as networking mechanisms that are developed in the future. Many different network protocols may be used to implement a network. These protocols are specialized computer programs that allow computers to communicate across a network. TCP/IP (Transmission Control Protocol/Internet Protocol), File Transfer Protocol (FTP) are examples of network protocols that may be used to communicate across the Internet, as an example of a suitable network protocol.

System bus 260 allows data to be transferred among the various components of computer system 200. Although computer system 200 is shown to contain only a single main processor and a single system bus, those skilled in the art will appreciate that the present invention may be practiced using a computer system that has multiple processors and/or multiple buses. In addition, the interfaces that are used in one or more embodiments may include separate, fully programmed microprocessors that are used to off-load compute-intensive processing from processor 210, or that may include I/O adapters to perform similar functions.

In one embodiment of the present invention, the software program for large file transfer residing in the operating system 226 is also invoked, thereby activating various modules present in the program. One or more of these modules assist in the transfer of the digital object 102 and make the process of transfer transparent to the user. The splitting module 228 splits the digital object 102 into a plurality of parts forming the first set of parts 114 and the set of remaining parts 116. The credential creating module 229 creates credential record 112 defining relationship between the plurality of parts. Thereafter, the transferring module 230 pushes first set of parts 114 along with credential record 112 to destination 106 using at least one push path 108. In other words, the transferring module 230 transfers first set of parts 114 to destination 106. In another embodiment of the present invention, timing module 231 manages a pre-defined expiration timer set on the first set of parts and the credential record. Further, fetching module 232 fetches set of remaining parts 116 using the credential record 112 to connect destination 106 to source 104. The timing module 231 ensures that the fetching module 232 fetches set of remaining parts 116 from source 104 within the expiry of the pre-defined expiration timer maintained by the timing module 231. The pre-defined expiration timer is used to remove the redundant data present on the source 104. Finally, the recreating module 234 reconstructs digital object 102 from set of remaining parts 116, first set of parts 114 and credential record 1 12.

The “modules” are software code that may be a callable routine or may be embedded into another program, i.e., an operating system or application program. For example, although the modules are shown as a part of operating system 226 in accordance with one embodiment of the present invention, it is equally within the scope of the present invention to provide a separate software application or utility such as a “large file transfer” program that could also provide splitting module 228, credential creating module 229, transferring module 230, timing module 231, fetching module 232 and recreating module 234. Each of these modules performs one or more of the method steps described in conjunction with FIG. 3. In accordance with another embodiment of the present invention, these modules may be provided as independent hardware modules present in an apparatus for transferring the digital object from source to destination. Each of these hardware modules may have the corresponding software module codes embedded into them to enable their functioning. In accordance with yet another embodiment of the present invention, the modules may be clubbed together in any combination thereof.

FIG. 3 is a flowchart describing a method 300 for transferring digital object 102 from source 104 to destination 106 in accordance with one embodiment of the present invention. Each of the following method steps are performed by one or more modules residing in the computer system 200 described in the conjunction with FIG. 2. The method starts at step 302 and proceeds to step 304 where splitting module 228 splits digital object 102 into a plurality of parts. Further, splitting module 228 segregates the plurality of parts into a first set of parts 114 and a set of remaining parts 116. The number of split parts are selected based on number of push path 108 user has to store the parts. For example, a user may have a CD as push path 108 where the size of the CD is not sufficient to contain digital object 102 in its entirety. In such a case, the digital object 102 is broken into 2 parts. A first part (i.e. equivalent to first set of parts 114) is transferred via the CD. The remaining size of the digital object 102 forms the second part (i.e. equivalent to the set of remaining parts 116), which is transferred through the pull path 1 10. Those skilled in the art will appreciate that the user may use any combination of the push path 108 available for transferring first set of parts 114. For example, the user may use a CD and a DVD to transfer first set of parts 114 to destination 106. In another embodiment of the present invention, the digital object 102 is split based on the number of emails that are to be used to transmit the first set of parts 114 from source 104 to destination 106. In other words, number of parts in the first set of parts 114 is determined based on the number of email attachments and capacity of the email attachments.

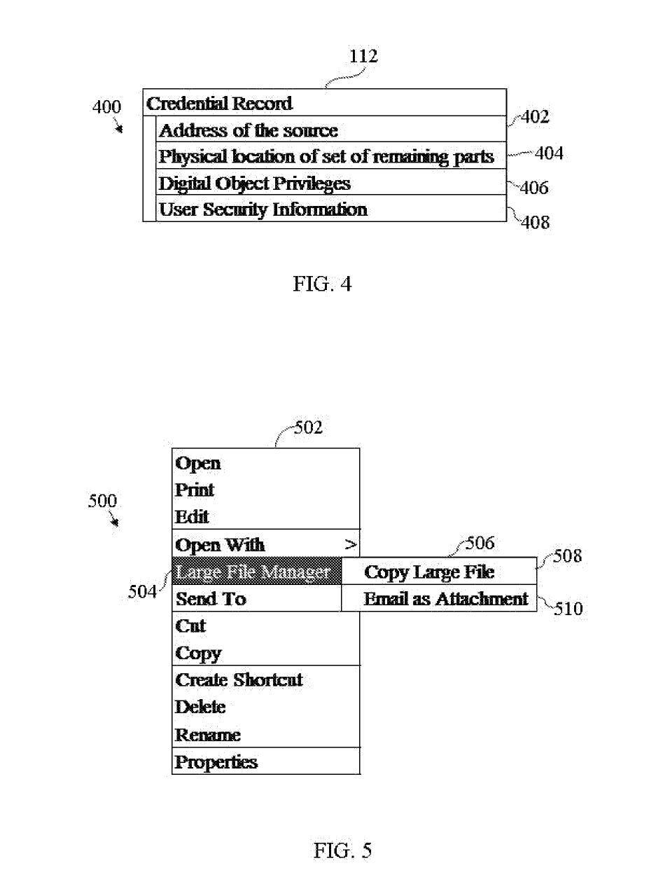

At the step 306, credential creating module 229 creates credential record 112 to store addressing information and/or retrieval instructions to retrieve set of remaining parts 116 using the pull path 110. In one embodiment, credential record 112 further stores order data and/or merging instruction to recreate digital object 102 from first set of parts 114 and one or more parts from set of remaining parts 116. In other words, credential record 112 defines the relationship between the plurality of parts of digital object 102. In one embodiment of the present invention, the credential record 112 contains information about set of remaining parts 116. The various information fields in credential record 112 are explained in conjunction with FIG. 4.

In one embodiment of the present invention, splitting module 228 stores the set of remaining part 116 at a predefined location on source 104. Consider a case when the sender wants to delete the file after sending the first set of parts to the destination. In such a case, the receiver must be able to access the set of remaining parts. Hence the set of remaining parts is copied to the pre-defined location at the source for future retrieval.

In another embodiment of the present invention, splitting module 228 compresses first set of parts 114 and set of remaining parts 116 source 104. Compressing is preformed in order to utilize a minimum amount of storage space at source 104. It will be appreciated by a person skilled in the art, that the compression is not mandatory and is performed only for space optimization with respect to the proposed technique. In yet another embodiment of the present invention, splitting module 228 further encrypts first set of parts 114 and/or credential record 112. The encryption may be added only to provide security during the data transfer. This encryption may be specific to the operating system under use. For example, encryption conforming to the operating system 226 is used in this case.

Thereafter at step 308, transferring module 230 transfers (or pushes) first set of parts 114 along with credential record 112 to destination 106 via at least one push path 108. Further, set of remaining parts 116 from the plurality of parts are kept at source 104 making them available via pull path 110. In another embodiment of the present invention, transferring module 230 sends credential record 112 independent of first set of parts 114. For example, the user may chose to send first set of parts 114 through a portable media as push path 108, while credential record 112 may be sent using an email as push path 108. In such a case the encryption may or may not be performed for both first set of parts 114 and credential record 112.

In another embodiment of the present invention, the timing module 231 associates a pre-defined expiration timer with at least one of first set of parts 114 and set of remaining parts 116. In one embodiment of the present invention, timing module 231 associates the pre-defined expiration timer only to set of remaining parts 116 when digital object 102 is deleted from source 106. The pre-defined expiration timer is attached to delete set of remaining parts 116 from source 104 on behalf of the user. The pre-defined expiration timer is added to remove the duplicate copies of the set of remaining parts 116 stored at source 104. The user is unaware of these duplicate copies hence this removal helps to minimize disk space utilization. In other cases, the pre-defined expiration timer is added to first set 114 and set of remaining parts 116, so as to delete both the parts separately on behalf of the user, since any one set of parts is incomplete without the presence of the other set. Also this serves as a security measure against unauthorized access of the digital object.

The pre-defined expiration timer maybe user-defined or system administrator-defined. For example, the pre-defined expiration timer may range from a year or several months to a week and even to few hours such as 24 Hrs to 72 Hrs, depending on the usage and preference settings of the user. The pre-defined expiration timer is actively managed by the operating system 226. For example, the timer may be synchronized with the software program of the operating system 226 which has its own mechanism to react to the expiry of the timer. Also the pre-defined expiration timer is useful in case where, if for some reasons, first set of parts 114 is not merged with set of remaining parts 116 and hence both the parts of digital object 102 are rendered useless without each other.

Different parts of digital object 102 are now present at different locations. For example, in this case, first set of parts 114 is present at destination 106 and set of remaining parts 116 is present at source 104. In order for a complete transfer of digital object 102 from source 104 and destination 106, the digital object needs to be recreated at the destination 106. Hence at step 310, fetching module 232 fetches the set of remaining parts 116 at destination 106 using credential record 112 to connect destination 106 to source 104 via at least one pull path 1 10. In an embodiment of the present invention, FTP may be used as pull path 110. In this manner, credential record 112 is used to automatically retrieve the set of remaining parts without any user intervention making the transfer process transparent to the user. Further, in accordance with an embodiment of the present invention, fetching module 232 fetches set of remaining parts 116 before the expiration of the pre-defined expiration timer. Thereafter, fetching module 232 decompresses first set of parts 114 (copied to destination 106) and set of remaining parts 116 (fetched at step 310). It will be apparent to person skilled in the art, that decompression is performed only if compression has already been performed by splitting module 228.

Thereafter, at step 312, recreating module 234 recreates digital object 102 at destination 106 using credential record 112, first set of parts 114 and set of remaining parts 116. The recreation includes merging of first set of parts 114 and set of remaining parts 116 at destination 106 to form digital object 102. Further, in accordance with an embodiment of the present invention, recreating module 234 generates an error message when one or more failure conditions are encountered. Examples of failure conditions are, without limitation, source 104 being inaccessible from destination 106, the expiration of set of remaining parts 116 and the incomplete transfer of set of remaining parts 116 to destination 106. Thereafter, the method terminates at step 314.

In another embodiment of the present invention, the digital object 102 is a large size email. In such a case, the email is divided into plurality of parts from which a first set of parts are sent to the destination. The first set of parts may appear to the user as the first screen shot of the message. The set of remaining parts of the email may be retrieved from the source as and when user scrolls down from the first screen shot of the email. In this case, step 310 is modified for partial retrieval of the set of remaining parts based on user demands. Hence, fetching module 232 dynamically fetches the set of remaining parts from the source depending on the user selected view. There may be a case where the user may not scroll down the entire email. In such cases, it is unnecessary to transfer the entire email. Hence the network bandwidth is efficiently utilized. Another example of this embodiment may be used in case of a media file transfer, such as, but not limited to, an MPEG or an MP3 file. The first set of parts would be a snippet of the media file. The set of remaining parts forming the rest of the media file may or may not be fetched based upon the user's discretion. This may be because the user may not like the snippet of the music file and hence does not wish to fetch the remaining file, thus saving the bandwidth.

FIG. 4 is a block diagram 400 depicting credential record 112 in accordance with an embodiment of the present invention. The credential record 112 includes information pertaining to first set of parts 114 and set of remaining parts 116, such as, address 402 of the source, the physical location 404 of the set of remaining parts on the source, one or more privileges 406 associated with the digital object, and user security information 408. In one embodiment of the present invention, address 402 of the source in credential record 112 may be an Internet Protocol (IP) address of source 104. In one embodiment of the present invention, credential record 112 is a header file or data field attached with (or appended to) first set of parts 114. In another embodiment of the present invention, credential record 112 is a trailer attached with first set of parts 1 14.

The credential record may optionally contain metadata information about digital object 102. In an exemplary case, credential record 112 may contain information about set of remaining parts 116 in form of a hash table and/or a hash address. The physical location 404 of the set of remaining parts on the source contains information about the predefined location where set of remaining parts 116 is stored at source 104. In such cases, the hash table is used to speed up the process of locating set of remaining parts 116 at source 104. In yet another embodiment of the present invention, the user security information 408 in credential record 112 is a user name and password protection on the first set of parts, so that only authorized personnel can access the files.

FIG. 5 is a sample user-interface 500 suitable for use in conjunction with various embodiments of the present invention. The figure shows a menu 502 listing the operations which the user may perform on a digital object 102 at source 104. The digital object 102 referred to here is a large sized digital object. Menu 502 includes a Large File Manager option 504 that producing a sub-menu 506 that lists a Copy Large File option 508 and an Email as Attachment option 510.

In accordance with an embodiment of the present invention, if the user selects Copy Large File option 508, the software program implementing the invention prompts the user to specify the media (i.e. the push path 108) to which the large file must be copied. Once the user specifies the media, the computer program code of the present invention calculates the available storage capacity on the specified media. Thus, the code decides the size of first set of parts 114 and creates credential record 112 accordingly. It further copies a combination of credential record 112 and first set of parts 114 on to the specified media. The user then pushes credential record 112 and first set of parts 114 to destination 106.

At destination 106, the user clicks on the first set of parts 114 which then unpacks itself copying data part in the first set of parts to a selected folder at the destination 106. Thereafter, the software program, automatically, using the credential record 112, retrieves the set of remaining parts 116 from the source 104 to destination 106, in the same selected folder in which the first set of parts 114 reside. The fetching of set of remaining parts at destination 106 is done via pull path 1 10. For example, the software program connects the destination 106 to source 104 via FTP using IP address information of source 104 present in credential record 112. Once fetched, both first set of parts 114 and set of remaining parts 116 are merged to recreate digital object 102. Hence this process is completely transparent to the user.

On the other hand, if the user selects Email as Attachment option 510, source 104 prepares the first set of parts 114 of digital object 102, and creates credential record 112. Thereafter, the email client at source 104 is prompted to launch an email composer. The new email in the email composer has an attachment that includes credential record 112 and first set of parts 114. The user may then compose and send the new email in a manner similar to an email with an ordinary attachment. Thus, the splitting of the large file is transparent to the user at source 104.

Similarly at destination 106, a user receives an email with credential record 112 and first set of parts 114 in an attachment. In one embodiment, the computer program code, according to the present invention, may be embodied as a plug-in module in the email client at destination 106. Alternatively, the computer program code of the present invention may be deployed as a stand-alone application at destination 106. In this embodiment, the combination of credential record 112 and first set of parts 114 may be allotted a unique file type, and the file type may then be associated with the stand-alone application according to the present invention. It will be apparent to one skilled the art that there may exist a number of ways to invoke the computer program code of the present invention at destination 106 in response to the receipt of an email containing a combination of credential record 112 and first set of parts 114 as an attachment. Once invoked, the computer program code fetches the set of remaining parts 116 from source 104 via at least one pull path 110. The code then reconstructs digital object 102 using first set of parts 114, the set of remaining parts 116, and credential record 112.

In various embodiments, the deployment of the present invention may be completely transparent to the user. For example, it may be deployed as an email plug-in that automatically determines whether email attachments should be sent as-is, or should be split. Similarly, the computer program code of the present invention may be embedded in the file manager of an operating system. It will be apparent to one skilled in the art that various embodiments of the present invention may provide a variety of end-user interfaces without deviating from the spirit and scope of the present invention.

One or more of the above mentioned embodiments of the invention have various advantages. There is minimum user intervention with a minimum skill set requirement. Also the process of fetching the set of remaining parts from the source to the destination is transparent to the user. Further, there is no need to use a dedicated storage medium; the capacity and the type of media used by the user are immaterial as there is no restriction to or a specific requirement for the same. The invention also increases the ease of data transfer as the user is only required to insert the media at the destination and access the credential record. The software program implementing the invention will thereafter fetch the remaining data from the source and merge it with the data in the media to form the original data file. Since this process is performed without any user intervention, it is transparent to the user.

In the aforesaid description, specific embodiments of the present invention have been described by way of examples with reference to the accompanying figures and drawings. One of ordinary skill in the art will appreciate that various modifications and changes can be made to the embodiments without departing from the scope of the present invention as set forth in the claims below. Accordingly, the specification and figures are to be regarded in an illustrative rather than a restrictive sense, and all such modifications are intended to be included within the scope of present invention.

What is claimed is:

1. A method for transferring a digital object from a source to a destination, the method comprising:
splitting the digital object into a plurality of parts comprising a first set of parts and a set of remaining parts;
creating a credential record defining a relationship between the plurality of parts, wherein the credential record comprises retrieval information for the set of remaining parts;
transferring the first set of parts along with the credential record to the destination using at least one push path;
fetching the set of remaining parts at the destination using the credential record to connect the destination to the source via at least one pull path; and
recreating the digital object at the destination using the first set of parts, the credential record and the set of remaining parts.

2. The method of claim 1, wherein the at least one push path is at least one of a portable media and an email attachment.

3. The method of claim 1, wherein the at least one pull path is selected from a group consisting of an Internet file transfer, an email attachment, a Bluetooth connection, a file transfer protocol (FTP) connection, a peer-to-peer (P2P) connection, a radio frequency (RF) connection, a Wi-Fi connection, a code division multiple access (CDMA) connection, a Global System for Mobile Communications (GSM) connection, an Evolution-Data Optimized (EVDO) connection, a Universal Mobile Telecommunications System (UMTS) connection, and a Wideband CDMA (WCDMA) connection.

4. The method of claim 1, wherein the splitting comprises determining number of parts in the first set of parts based on at least one of number of the push path and a maximum size limit of the push path.

5. The method of claim 1 further comprising storing the set of remaining parts at a predefined location at the source.

6. The method of claim 1 further comprising associating an expiration timer with at least one of the first set of parts and the set of remaining parts.

7. The method of claim 1 further comprising compressing one or more parts in the plurality of parts.

8. The method of claim 1, wherein the credential record comprises at least one of a network address of the source, a physical location of the digital object, one or more privileges associated with the digital object, user information, information about the set of remaining parts, and security information related to the digital object.

9. The method of claim 1 further comprising encrypting at least one of the first set of parts and the credential record.

10. The method of claim 1, wherein the fetching comprises retrieving partially the set of remaining parts based on a demand from a user.

11. The method of claim 1 further comprising generating an error message on encountering one or more failure conditions including source being inaccessible from the destination, expiry of the set of remaining parts at the source, and an incomplete transfer of the set of remaining parts to the destination.

12. A computer program product comprising a computer useable medium including a computer usable program code for transferring a digital object from a source to a destination, the computer program product comprising:
computer usable program code for splitting the digital object into a plurality of parts comprising a first set of parts and a set of remaining parts;
computer usable program code for creating a credential record defining a relationship between the plurality of parts, wherein the credential record comprises retrieval information for the set of remaining parts;
computer usable program code for transferring the first set of parts along with the credential record to the destination using at least one push path;
computer usable program code for fetching the set of remaining parts at the destination using the credential record to connect the destination to the source via at least one pull path; and
computer usable program code for recreating the digital object at the destination using the first set of parts, the credential record and the set of remaining parts.

13. The computer program product of claim 12, wherein the computer usable program code for splitting comprises computer usable program code for determining the number of parts in the first set of parts based on at least one of number of the push path and a maximum size limit of the push path.

14. The computer program product of claim 12 further comprising computer usable program code for storing the set of remaining parts at a predefined location at the source.

15. The computer program product of claim 12 further comprising computer usable program code for associating an expiration timer with at least one of the first set of parts and the set of remaining parts.

16. The computer program product of claim 12 further comprising computer usable program code for compressing one or more parts in the plurality of parts.

17. The computer program product of claim 12 further comprising computer usable program code for encrypting at least one of the first set of parts and the credential record.

18. The computer program product of claim 12, wherein computer usable program code for fetching comprises computer usable program code for retrieving partially the set of remaining parts based on a demand from a user.

19. The computer program product of claim 12 further comprising computer usable program code for generating an error message on encountering one or more failure conditions including source being inaccessible from the destination, expiry of the set of remaining parts at the source, and an incomplete transfer of the set of remaining parts to the destination.

20. An apparatus for transferring a digital object from a source to a destination, the apparatus comprising:
a splitting module to split the digital object into a plurality of parts comprising a first set of parts and a set of remaining parts;
a credential record creator to create a credential record defining a relationship between the plurality of parts, wherein the credential record comprises retrieval information for the set of remaining parts;
a transferring module to transfer the first set of parts along with the credential record to the destination using at least one push path;
a fetching module to fetch the set of remaining parts at the destination using the credential record to connect the destination to the source via at least one pull path; and
a recreating module to recreate the digital object at the destination using the first set of parts, the credential record and the set of remaining parts.
